(19) United States
(12) Patent Application Publication
(10) Pub. No.: US 2011/0260992 A1
(43) Pub. Date: Oct. 27, 2011

(54) PANEL CONTROL DEVICE AND OPERATION METHOD THEREOF

(75) Inventors: Ching-Ho Hung, Hsinchu City (TW); Wing-Kai Tang, Hsinchu City (TW); Ching-Chun Lin, Taipei County (TW); Hsien-Lung Chen, Taichung City (TW); Tsen-Wei Chang, Taichung County (TW); Jiun-Jie Tsai, Hsinchu City (TW)

(73) Assignee: NOVATEK MICROELECTRONICS CORP., Hsinchu (TW)

(21) Appl. No.: 13/008,910

(22) Filed: Jan. 19, 2011

(30) Foreign Application Priority Data
Apr. 21, 2010 (TW) 99112485

(51) Int. Cl. G06F 3/041

(52) U.S. Cl. 345/173

(57) ABSTRACT

A panel control device and an operation method thereof are provided. The panel control device includes a touch controller and a display controller. The display controller drives a touch display panel module to display an image. The touch controller senses a touch event of the touch display panel module. Wherein, the sensing operation of the touch controller is enabled/disabled in accordance with the driving operation of the display controller.

### CROSS-REFERENCE TO RELATED APPLICATION

This application claims the priority benefit of Taiwan application serial no. 99112485, filed on Apr. 21, 2010. The entirety of the above-mentioned patent application is hereby incorporated by reference herein and made a part of this specification.

### BACKGROUND OF THE INVENTION

1. Field of the Invention

The present invention relates to a touch control device. More particularly, the present invention relates to a panel control device of a touch display panel module and an operation method thereof.

2. Description of Related Art

In a present display system having a touch control function, the touch control system and the display system are respectively independent systems. Since system integration and low cost are unchanged developing trends of the electronics industry, if a controller of the touch control system and a controller of the display system are integrated as a same piece of integrated circuit (IC), an application circuit on a printed circuit board (PCB) can be effectively simplified. Generally, the touch control system has to detect an electric difference between a touch operation period and an un-touch operation period. Since the electric difference is generally tiny, the noise immunity has to be improved. However, with a development trend of integrating the touch control system and the display system, interference between the touch control system and the display system becomes serious.

### SUMMARY OF THE INVENTION

The present invention is directed to a panel control device and an operation method thereof, by which a touch control system and a display system are synchronized to mitigate interference between the touch control system and the display system.

The present invention provides a panel control device including a display controller and a touch controller. The display controller drives a touch display panel module to display an image. The touch controller senses a touch event of the touch display panel module. Wherein, a sensing operation of the touch controller is enabled/disabled in accordance with a driving operation of the display controller.

The present invention provides a method for operating a panel control device. The method can be described as follows. A touch display panel module is driven to display an image. A touch event of the touch display panel module is sensed. A sensing operation is correspondingly enabled/disabled in accordance with a driving operation.

According to the above descriptions, in the panel control device and the operation method thereof disclosed by the present invention, the sensing operation of the touch controller is enabled/disabled in accordance with the driving operation of the display controller. Therefore, in the panel control device and the operation method thereof disclosed by the present invention, the touch control system and the display system can be synchronized to mitigate interference between the touch control system and the display system.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating input data of a general display system.

FIG. 2 is a block schematic diagram illustrating a panel control device according to an embodiment of the present invention.

FIG. 3 is a diagram illustrating a timing relationship between a polarity control signal and a driving voltage according to an embodiment of the present invention.

FIG. 4 is a diagram illustrating a timing relationship between a line latch signal and a driving voltage according to an embodiment of the present invention.

FIG. 5 is a flowchart illustrating a method for operating a panel control device according to an embodiment of the present invention.

### DESCRIPTION OF THE EMBODIMENTS

In a general display system, horizontal and vertical display information and control information have fixed periods and patterns, and a touch control system also calculates a touch position according to horizontal and vertical detecting information. In the following embodiment, the touch control system and the display system are synchronized, and application features and functions thereof are suitably arranged. Especially, when a touch controller of the touch control system and a display controller of the display system are integrated into a same piece of integrated circuit (IC), an effect of mitigating the interference between the touch control system and the display system can be more effective.

On the other hand, when a display panel and a touch panel are further integrated, i.e. integrated into a same fabrication process, display cells are located closer to touch detecting devices (for example, capacitors), so that the interference is more obvious. In case of such touch control system, the display system may have a greater chance to cause the noise interference. Therefore, it is important to synchronize the touch control system and the display system to avoid interference there between.

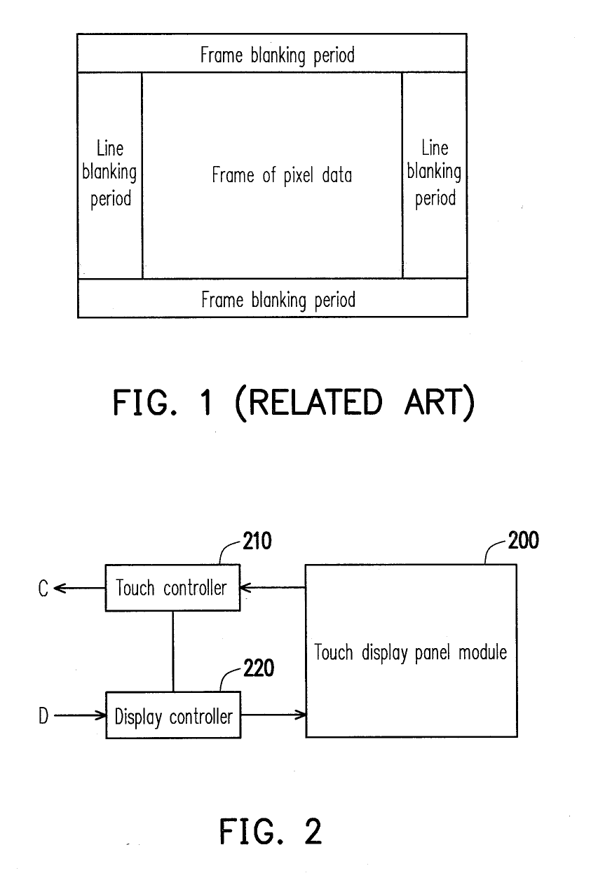

FIG. 1 is a schematic diagram illustrating input data of a general display system. In the general display system, a timeslot of a frame is defined by a vertical synchronization signal Vsync, and in one frame, a plurality of horizontal synchronization signals Hsync define timeslots of a plurality of lines (scan lines or horizontal lines). Each frame has a frame blanking period, and each line has a line blanking period. In operation of a conventional display system, a display controller controls a source driver to sequentially store pixel data during a transmission period of the pixel data. After the pixel data of one line are stored, the display controller controls the source driver to simultaneously send potentials corresponding to the pixel data to the display panel, so that the display panel can display a corresponding image according to a timing of a gate driver. In this way, an operation procedure of the display system has a certain sequence and period, and accordingly circuit power consumption of the display system also has a certain sequence and period. A polarity inversion mode used by the display system also influences the sequence and period of the power consumption of the system.

FIG. 2 is a block schematic diagram illustrating a panel control device according to an embodiment of the present invention. The panel control device includes a touch controller 210 and a display controller 220. A touch display panel module 200 of FIG. 2 includes a display panel and a touch panel. The display and the touch panel can be two independent panels, and can also be integrated into a single panel.

The display controller 220 receives pixel data D, and drives the display panel of the touch display panel module 200 through a source driver and a gate driver (which is referred to as a driving operation hereinafter), so that the display panel can display an image. According to a design requirement, the source driver and the gate driver can be configured in the touch display panel module 200, and can also be configured in the display controller 220. The touch controller 210 senses a touch event of the touch display panel module 200 (which is referred to as a sensing operation hereinafter), and outputs a touch coordinates C.

The sensing operation of the touch controller 210 is enabled/disabled in accordance with the driving operation of the display controller 220. Namely, when the touch control system and the display system are synchronized, the touch control system can detect a touch operation of the touch panel during a suitable time section of the display system that has lesser power consumption or little noise interference, for example, during the line blanking period or the frame blanking period, so as to achieve a minimum noise interference and obtain a more precise detecting value (the touch coordinates C). Moreover, according to the present embodiment, a burden of processing the noise interference can be reduced, and a difficulty of determining the detecting value interfered by the noise can also be reduced.

In a first embodiment, the display controller 220 can output a vertical synchronization signal to the touch controller 210. As described above, the vertical synchronization signal defines the frame blanking period of one frame. The display controller 220 does not drive the touch display panel module 200 during the frame blanking period, i.e. the display system is not liable to influence the touch control system during the frame blanking period. Therefore, the touch controller 210 can enable the sensing operation during the frame blanking period according to the vertical synchronization signal, and disable the sensing operation after the frame blanking period is ended.

In a second embodiment, the display controller 220 outputs a horizontal synchronization signal to the touch controller 210. As described above, the horizontal synchronization signal defines a plurality of line timeslots in one frame and the line blanking period between two adjacent line timeslots. The display controller 220 does not drive the touch display panel module 200 during the line blanking period, i.e. the display system is not liable to influence the touch control system during the line blanking period. Therefore, the touch controller 210 can enable the sensing operation during the line blanking period according to the horizontal synchronization signal, and disable the sensing operation after the line blanking period is ended.

In a third embodiment, the display controller 220 outputs the vertical synchronization signal and the horizontal synchronization signal to the touch controller 210. Therefore, the touch controller 210 can enable the sensing operation during the frame blanking period and/or the line blanking period according to the vertical synchronization signal and the horizontal synchronization signal, and disable the sensing operation during a period other than the frame blanking period and the line blanking period.

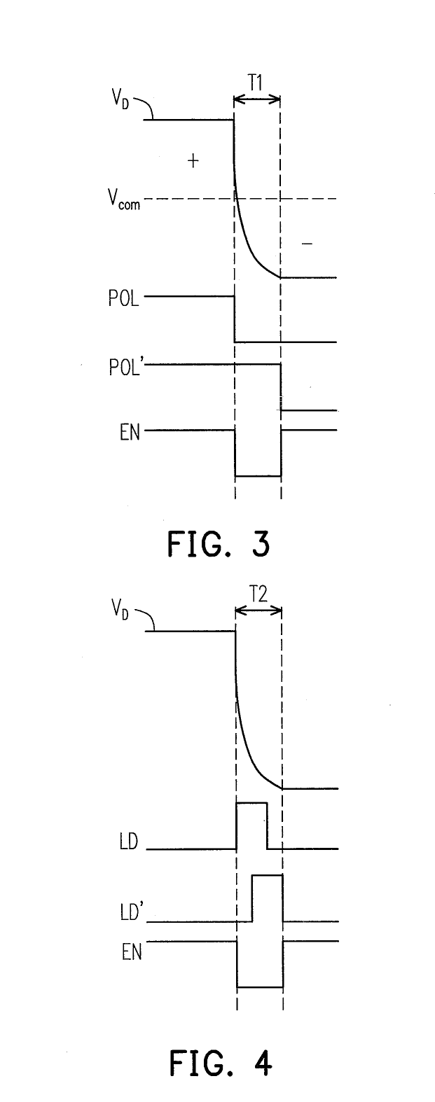

In a fourth embodiment, the display controller 220 outputs a polarity control signal POL to the touch controller 210. The display controller 220 can also output the polarity control signal POL to the source driver (not shown). FIG. 3 is a diagram illustrating a timing relationship between the polarity control signal POL and a driving voltage V_{D} according to an embodiment of the present invention. When the polarity control signal POL is transited, the source driver changes a polarity of the driving voltage V_{D} of the touch display panel module 200 according to the polarity control signal POL, wherein the polarity of the driving voltage V_{D} is determined according to a common voltage Vcom. During a transient state (for example, a polarity inversion period T1 shown in FIG. 3) when the polarity of the driving voltage V_{D} is changed, the source drive spends relatively more power to change the polarity of the driving voltage V_{D}. Namely, the display system is liable to influence the touch control system during the polarity inversion period T1. Therefore, the touch controller 210 can disable the sensing operation during the polarity inversion period T1 according to the polarity control signal POL, and enable the sensing operation after the polarity inversion period T1 is ended. The touch controller 210 can define the polarity inversion period T1 by any approach. For example, the touch controller 210 delays the polarity control signal POL to obtain a delay signal POL′, and then performs an XNOR operation to the polarity control signal POL and the delay signal POL′ to obtain an enable signal EN, as that shown in FIG. 3. The touch controller 210 can enable/disable the sensing operation according to a level of the enable signal EN.

In a fifth embodiment, the polarity control signal POL is output to the display controller 220 from the touch controller 210. Similar to the fourth embodiment, the touch controller 210 disables the sensing operation during the polarity inversion period T1 in the fifth embodiment, and the fourth embodiment can be referred for detailed descriptions thereof. A difference between the fifth embodiment and the fourth embodiment is that in the present embodiment, the polarity control signal POL is provided by the touch controller 210. When the touch controller 210 transits the polarity control signal POL, the display controller 220 changes the polarity of the driving voltage V_{D} according to the polarity control signal POL.

In a sixth embodiment, the display controller 220 outputs a line latch signal LD to the touch controller 210. The display controller 220 also outputs the line latch signal LD to the source driver (not shown). FIG. 4 is a diagram illustrating a timing relationship between the line latch signal LD and the driving voltage V_{D} according to an embodiment of the present invention. When the line latch signal LD has a pulse, the source driver can simultaneously send potentials corresponding to the pixel data to the display panel, so that the level of the driving voltage V_{D} of the touch display panel module 200 is changed (i.e. a gray level is changed). During a transient state (for example, a data inversion period T2 shown in FIG. 4) when the level of the driving voltage V_{D} is changed, the source drive spends relatively more power to change the level of the driving voltage V_{D}. Namely, the display system is liable to influence the touch control system during the data inversion period T2. Therefore, the touch controller 210 can disable the sensing operation during the data inversion period T2 according to the line latch signal LD, and enable the sensing operation after the data inversion period T2 is ended. The touch controller 210 can define the data inversion period T2 by any approach. For example, the touch controller 210 delays the line latch signal LD to obtain a delay signal LD′, and then performs a NOR operation to the line latch signal LD and the delay signal LD′ to obtain an enable signal EN, as that shown in FIG. 4. The touch controller 210 can enable/disable the sensing operation according to a level of the enable signal EN. In another embodiment, if a pulse width of the line latch signal LD is wide enough, the line latch signal LD can directly serve as a disable signal (i.e. an inverted signal of the enable signal EN) used for controlling the sensing operation, and the aforementioned delay operation and the NOR operation are omitted.

In a seventh embodiment, the line latch signal LD is output to the display controller 220 from the touch controller 210. Similar to the sixth embodiment, the touch controller 210 disables the sensing operation during the data inversion period T2, and the sixth embodiment can be referred for detailed descriptions thereof. A difference between the seventh embodiment and the sixth embodiment is that in the present embodiment, the line latch signal LD is provided by the touch controller 210. When the touch controller 210 outputs the line latch signal LD having a pulse to the display controller 220, the display controller 220 correspondingly changes the level of the driving voltage V_{D}.

In an eighth embodiment, the display controller 220 can output the enable signal EN to the touch controller 210. Namely, the display controller 220 can generate the enable signal EN to the touch controller 210 according to the method disclosed in any one of the aforementioned embodiments. The touch controller 210 correspondingly enables or disables the sensing operation according to the enable signal EN.

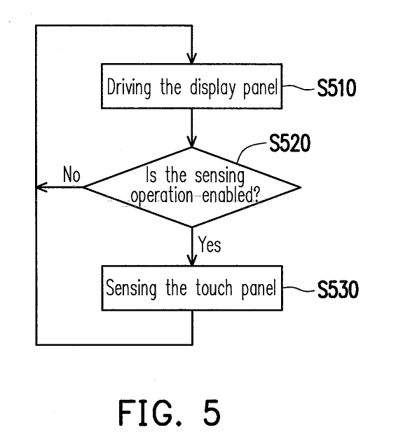

A method for operating the panel control device is disclosed below with reference of the above embodiments. FIG. 5 is a flowchart illustrating a method for operating the panel control device according to an embodiment of the present invention. In step S510, the display controller 220 drives the touch display panel module 200 to display an image. In step S520, the touch controller 210 correspondingly determines whether or not to enable/disable the sensing operation according to the driving operation of the display controller 220. If the touch controller 210 disables the sensing operation in the step S520, the step S510 is repeated, and if the touch controller 210 enables the sensing operation in the step S520, a step S530 is executed, by which the touch controller 210 senses a touch event of the touch display panel module 200. Detailed implementations of the step S520 have been described in the aforementioned first to eighth embodiments, and therefore detailed description thereof is not repeated.

In summary, according to the panel control device and the operation method thereof disclosed by the present invention, the sensing operation of the touch controller 210 is enabled/disabled in accordance with the driving operation of the display controller 220. Therefore, in the panel control device and the operation method thereof disclosed by the present invention, the touch control system and the display system can be synchronized to mitigate interference between the touch control system and the display system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A panel control device, comprising:
a display controller, for driving a touch display panel module to display an image; and
a touch controller, for sensing a touch event of the touch display panel module, wherein a sensing operation of the touch controller is enabled/disabled in accordance with a driving operation of the display controller.

2. The panel control device as claimed in claim 1, wherein the display controller outputs a vertical synchronization signal to the touch controller, and the touch controller enables the sensing operation during a frame blanking period according to the vertical synchronization signal.

3. The panel control device as claimed in claim 1, wherein the display controller outputs a horizontal synchronization signal to the touch controller, and the touch controller enables the sensing operation during a line blanking period according to the horizontal synchronization signal.

4. The panel control device as claimed in claim 1, wherein the display controller outputs a vertical synchronization signal and a horizontal synchronization signal to the touch controller, and the touch controller enables the sensing operation during a frame blanking period or a line blanking period according to the vertical synchronization signal and the horizontal synchronization signal.

5. The panel control device as claimed in claim 1, wherein the display controller outputs a polarity control signal to the touch controller, and the touch controller disables the sensing operation during a polarity inversion period according to the polarity control signal, and enables the sensing operation during a period other than the polarity inversion period.

6. The panel control device as claimed in claim 1, wherein the touch controller outputs a polarity control signal to the display controller, and the touch controller disables the sensing operation and transits the polarity control signal during a polarity inversion period.

7. The panel control device as claimed in claim 1, wherein the display controller outputs a line latch signal to the touch controller, and the touch controller disables the sensing operation during a data inversion period according to the line latch signal, and enables the sensing operation during a period other than the data inversion period.

8. The panel control device as claimed in claim 1, wherein the touch controller disables the sensing operation and outputs a line latch signal to the display controller during a data inversion period.

9. The panel control device as claimed in claim 1, wherein the display controller outputs an enable signal to the touch controller, and the touch controller correspondingly enables or disables the sensing operation according to the enable signal.

10. A method for operating a panel control device, comprising:
performing a driving operation for driving a touch display panel module to display an image;
performing a sensing operation for sensing a touch event of the touch display panel module; and
correspondingly enabling/disabling the sensing operation in accordance with the driving operation.

11. The method for operating the panel control device as claimed in claim 10, wherein the step of enabling/disabling the sensing operation comprises:
enabling the sensing operation during a frame blanking period according to a vertical synchronization signal.

12. The method for operating the panel control device as claimed in claim 10, wherein the step of enabling/disabling the sensing operation comprises:
enabling the sensing operation during a line blanking period according to a horizontal synchronization signal.

13. The method for operating the panel control device as claimed in claim 10, wherein the step of enabling/disabling the sensing operation comprises:
enabling the sensing operation during a frame blanking period or a line blanking period according to a vertical synchronization signal and a horizontal synchronization signal.

14. The method for operating the panel control device as claimed in claim 10, wherein the step of enabling/disabling the sensing operation comprises:
disabling the sensing operation during a polarity inversion period according to a polarity control signal; and
enabling the sensing operation during a period other than the polarity inversion period.

15. The method for operating the panel control device as claimed in claim 10, wherein the step of enabling/disabling the sensing operation comprises:
disabling the sensing operation during a data inversion period according to a line latch signal; and
enabling the sensing operation during a period other than the data inversion period.
